(19) United States
(12) Patent Application Publication
(10) Pub. No.: US 2019/0184397 A1
(43) Pub. Date: Jun. 20, 2019

(54) THERMALLY DRIVEN DIGITAL MICROFLUIDIC CHIP, FABRICATING METHOD AND CONTROL METHOD THEREOF

(71) Applicants: Beijing BOE Optoelectronics Technology Co., Ltd., Beijing (CN); BOE TECHNOLOGY GROUP CO., LTD., Beijing (CN)

(72) Inventors: Mingyang Lv, Beijing (CN); Yue Li, Beijing (CN); Jinyu Li, Beijing (CN); Yanchen Li, Beijing (CN); Yu Zhao, Beijing (CN); Dong Wang, Beijing (CN); Shaojun Hou, Beijing (CN); Dawei Feng, Beijing (CN); Wang Guo, Beijing (CN)

(21) Appl. No.: 16/219,703

(22) Filed: Dec. 13, 2018

(30) Foreign Application Priority Data
Dec. 13, 2017 (CN) 201711330874.3

(51) Int. Cl. B01L 3/00

(52) U.S. Cl. CPC B01L 3/502784; B01L 3/502707; B01L 2400/0442; B01L 2300/0838; B01L 2300/0887; B01L 2200/12

(57) ABSTRACT

The present disclosure provides a digital microfluidic chip, a fabricating method and a control method thereof. The digital microfluidic chip includes: at least one substrate, a capillary channel, a plurality of first electrothermal components and a plurality of first switch elements. The capillary channel is disposed at at least one of the substrate; the plurality of first electrothermal components are disposed at the substrate and distributed to be spaced apart in an extending direction of the capillary channel; and each of the first switch elements is coupled with a current circuit with which the first electrothermal components are coupled, and receiving a control signal to control closure of a current circuit coupled with which the plurality of first electrothermal components are coupled.

### CROSS-REFERENCE TO RELATED APPLICATIONS

The present application is based on and claims priority to Chinese Application No. 201711330874.3, filed on Dec. 13, 2017, entire contents of which is hereby incorporated by reference.

### TECHNICAL FIELD

The present disclosure relates to the field of microfluidic technology, and in particular, to a digital microfluidic chip, a fabricating method, and a control method thereof.

### BACKGROUND

The microfluidic chip technology integrates basic operation units such as sample preparation, reaction, separation, and detection into a centimeter-scale chip. This technology greatly reduces the cost of a sample and improves the detection efficiency. It is popular and widely used in biology, chemistry, medicine and other fields in recent years.

At present, the mainstream driving method for a microfluidic chip is electrode driving, which is also called voltage digital microfluidic. The voltage digital microfluidic is to place the droplet within a capillary channel having a hydrophobic layer. By the electrowetting effect, the wettability between the droplet and the hydrophobic layer corresponding to the electrode is increased by applying a voltage between electrodes under the droplet and the hydrophobic layer, thus forming an asymmetric deformation of the droplet and creating an internal pressure difference, and thus realizing the directional movement and mixing of the droplet.

However, in order to obtain sufficient droplet driving force, the voltage digital microfluidic chip needs to spin-coat a hydrophobic material or to form a hydrophobic structure on the surface of the capillary channel. When no voltage is applied to the droplet, the hydrophobic layer is not wetted. When a voltage is applied to the droplet, the hydrophobic layer is wetted, thus obtaining a larger deformation and a larger internal pressure difference. Therefore, the process of the chip is difficult and costly. In addition, when the chip is cleaned, it is easy to damage the hydrophobic layer, which has an adverse impact on the repeated use.

It should be noted that the information disclosed in the background section above is only intended to enhance understanding of the background of the present disclosure, and thus may include information that does not constitute prior art known to those of ordinary skill in the art.

### SUMMARY

According to an aspect of the present disclosure, a digital microfluidic chip includes at least one substrate, a capillary channel, a plurality of first electrothermal components and a plurality of first switch elements. The capillary channel is disposed at at least one of the substrate. The plurality of first electrothermal components are disposed at at least one of the substrate and distributed to be spaced apart in an extending direction of the capillary channel. Each of the first switch elements is coupled with a current circuit with which the first electrothermal components are coupled, and receives a control signal to control closure of a current circuit coupled with which the plurality of first electrothermal components are coupled.

According to an aspect of the present disclosure, the substrate includes a first substrate and a second substrate disposed opposite to the first substrate, the capillary channel is disposed at the first substrate and/or the second substrate, and the plurality of first electrothermal components are disposed at the first substrate.

According to an aspect of the present disclosure, the digital microfluidic chip further includes a plurality of second electrothermal components disposed at the second substrate and distributed to be spaced apart in the extending direction of the capillary channel and a plurality of second switch elements. Each of the second switch elements is coupled with a current circuit with which the second electrothermal components are coupled, and receives a control signal to control closure of a current circuit with which the plurality of second electrothermal components are coupled.

According to an aspect of the present disclosure, surfaces of the first switch element and the second switch element are covered with an insulating material.

According to an aspect of the present disclosure, a bonding surface of the first substrate and/or the second substrate is disposed with a microfluidic channel. The bonding surface of the first substrate is disposed opposite to the bonding surface of the second substrate. The first substrate is bonded to the second substrate, and the microfluidic channel defines the capillary channel.

According to an aspect of the present disclosure, a bonding surface of the first substrate and/or the second substrate is provided with the microfluidic channel. The first substrate is bonded to the second substrate. The microfluidic channel defines the capillary channel.

According to an aspect of the present disclosure, the bonding surface of the first substrate is provided with the microfluidic channel, the second substrate is bonded to the first substrate, and the microfluidic channel of the bonding surface of the first substrate defines the capillary channel.

According to an aspect of the present disclosure, the bonding surfaces of the first substrate and the second substrate are provided with microfluidic channels, the first substrate is bonded to the second substrate, and the microfluidic channel at the bonding surface of the first substrate and the microfluidic channel at the bonding surface of the second substrate are disposed opposite to each other, and combined to define the capillary channel.

According to an aspect of the present disclosure, surfaces of the first electrothermal component, the second electrothermal component, and the insulating material are provided with liquid-resisting material.

According to an aspect of the present disclosure, said liquid-resisting material is a thermally conductive material.

According to an aspect of the present disclosure, the first electrothermal component and the second electrothermal component are electrothermal resistance wires. The insulating material is polyvinyl chloride resin. The liquid-resisting material is indium tin oxide.

According to an aspect of the present disclosure, the first switch element is disposed at the same layer as the first electrothermal component. The second switch element is disposed at the same layer as the second electrothermal component.

According to an aspect of the present disclosure, the first switch element and/or the second switch element are thin film transistors.

According to an aspect of the present disclosure, an inner surface of the capillary channel is not provided with a hydrophobic layer.

According to an aspect of the present disclosure, a fabricating method of a digital microfluidic chip is provided. The fabricating method of a digital microfluidic chip includes

providing at least one substrate, providing a capillary channel at at least one of the substrate, providing a plurality of first electrothermal components at the substrate, the plurality of first electrothermal components being distributed to be spaced apart in an extending direction of the capillary channel, and providing a first switch element coupled with a current circuit with which each of the first electrothermal components is coupled, so as to control closure of the current circuit with which the plurality of first electrothermal components are coupled.

According to an aspect of the present disclosure, the substrate includes a first substrate and a second substrate disposed opposite to the first substrate. The capillary channel is disposed at the first substrate and/or the second substrate. The plurality of first electrothermal components are disposed at the first substrate.

According to an aspect of the present disclosure, the fabricating method further includes providing a plurality of second electrothermal components at the second substrate, the second electrothermal components being distributed to be spaced apart in the extending direction of the capillary channel, and providing a second switch element coupled with a current circuit with which the plurality of second electrothermal components are coupled to control closure of the current circuit.

According to an aspect of the present disclosure, providing a capillary channel at a first substrate and/or a second substrate disposed corresponding to each other includes

providing a microfluidic channel at bonding surfaces of the first substrate and/or the second substrate and bonding the second substrate at the first substrate, in which the microfluidic channel defines the capillary channel.

According to an aspect of the present disclosure, providing a capillary channel at a first substrate and/or a second substrate disposed corresponding to each other includes

providing a microfluidic channel at a bonding surface of the first substrate and/or the second substrate, and bonding the second substrate to the first substrate, the microfluidic channel defining the capillary channel.

According to an aspect of the present disclosure, a control method of a digital microfluidic chip includes realizing a directional movement of a droplet within the digital microfluidic chip by varying a temperature on both side of the droplet within the digital microfluidic chip.

The above general description and the following detailed description are intended to be illustrative and not restrictive of the present disclosure.

### BRIEF DESCRIPTION OF THE DRAWINGS

The accompanying drawings are incorporated in and constitute part of the specification, show the arrangements of the present disclosure and are intended to explain the principle of the present disclosure together with the description. It is apparent that the accompanying drawings in the following description are only some of the arrangements of the present disclosure, and other drawings may be obtained from these accompanying drawings by those skilled in the art without any creative work.

FIG. 1 is a schematic structural view of an arrangement of a digital microfluidic chip according to the present disclosure;

FIG. 2 is a schematic structural view of an arrangement of a digital microfluidic chip according to the present disclosure;

FIG. 3 is a cross-sectional view along the capillary channel in an arrangement of the digital microfluidic chip of the present disclosure;

FIG. 4 is a cross-sectional view along the capillary channel in another arrangement of the digital microfluidic chip of the present disclosure;

FIG. 5 is a flow chart of an arrangement of a fabricating method of a digital microfluidic chip of the present disclosure; and

FIG. 6 is a flow chart of another arrangement of a fabricating method of a digital microfluidic chip of the present disclosure.

### DETAILED DESCRIPTION

Example arrangements will now be described more fully with reference to the accompanying drawings. However, the example arrangements can be embodied in a variety of forms, and should not be construed as being limited to the arrangements set forth herein; rather, these arrangements are provided so that this disclosure will be thorough and complete, and the concepts of the example arrangements will be fully given to those skilled in the art. The same reference numerals in the drawings denote the same or similar structures, and thus their detailed descriptions will be omitted.

Although the relative terms such as “on”, “below”, “upper” and “lower” are used in the specification to describe the relative relationship of one component to another component, these terms are used in this specification for convenience only, for example, a direction in the example according to the accompanying drawings. It should be understood that if the device is turned upside down, the “upper” component described above will become a “lower” component. Other relative terms, such as “high”, “low”, “top”, “bottom”, “left”, “right” or the like, also have similar meanings. When a structure is “on” another structure, it is possible that the structure is integrally formed on another structure, or that the structure is “directly” disposed on another structure, or that the structure is “indirectly” disposed on the other structure through other structures.

The terms such as “a”, “an”, “the” and “said” are used to indicate the presence of one or more elements/components. The terms “comprise”, “include”, “have”, “contain” and their variants are used to be open-type and are meant to include additional elements/components, etc., in addition to the listed elements/components/etc.

The exemplary arrangement provides a digital microfluidic chip. The digital microfluidic chip includes: at least one substrate, a capillary channel 3, a plurality of first electrothermal components 4 and a plurality of first switch elements 5. The capillary channel 3 is disposed at at least one of the substrate; the plurality of first electrothermal components 4 are disposed at the substrate and distributed to be spaced apart in an extending direction of the capillary channel 3; and each of the first switch elements 5 is coupled with a current circuit with which the first electrothermal components 4 are coupled, and receiving a control signal to control closure of a current circuit coupled with which the plurality of first electrothermal components 4 are coupled.

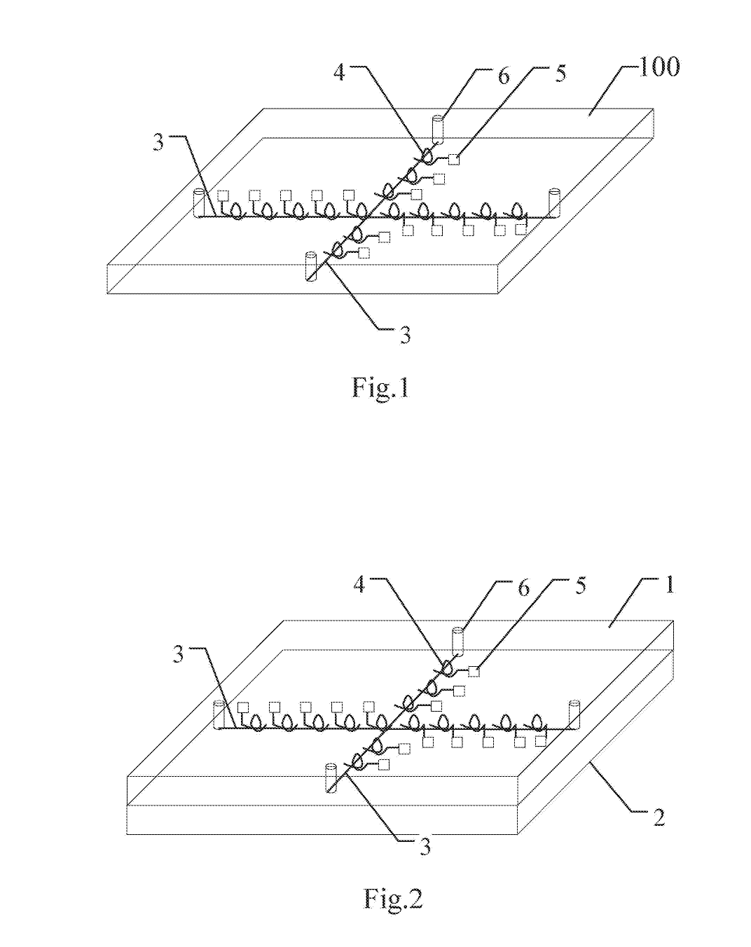

FIG. 1 and FIG. 2 are schematic structural views of two arrangement of a digital microfluidic chip according to the present disclosure. As shown in FIG. 1, there is one substrate 100; as shown in FIG. 2, there are two substrates including a first substrate 1 and a second substrate 2 disposed opposite to the first substrate 1; the capillary channel 3 is disposed at the first substrate and/or the second substrate; the plurality of first electrothermal components 4 are disposed at the first substrate 1.

It should be noted that the first switch element 5 may be a field effect transistor including a drain, a source and a gate. When a gate voltage reaches a breakover voltage, the source and the drain are conducted; and when the gate voltage is less than the breakover voltage, the source and the drain are not conducted. The drain and the source of the first switch element 5 may be coupled with a current circuit with which the first electrothermal component 4 is coupled, and the gate receives a control signal. The current circuit refers to a current which runs through the conducted first electrothermal component 4. The control signal may ensure the source and drain of the first switch element 5 to be conducted to communicate the current circuit with which the first electrothermal component 4 is coupled, and the first electrothermal component 4 generates heat in a conducting state to heat the droplet.

The exemplary arrangement provides a digital microfluidic chip, a fabricating method and a control method thereof. The digital microfluidic chip varies a surface tension on both sides of the droplet by varying a temperature on both sides of the droplet in the capillary channel at the chip, thus causing the surface tension on both sides of the droplet to be unbalanced, and thus realizing a directional movement of the droplet within the capillary channel. Compared with the related art, on the one hand, the digital microfluidic chip can realize the directional movement of the droplet without providing a hydrophobic layer, it also has a simple structure, low cost and may be recycled. On the other hand, the digital microfluidic chip has a larger driving force.

It should be noted that the principle of heating a surface of the droplet (i.e., a droplet surface) to reduce its surface tension is: when the temperature of the droplet surface increases, a molecular kinetic energy of the droplet surface increases, and an attraction between molecules decreases; a molecular concentration of the droplet surface decreases as the temperature increases; thus, the surface tension of the droplet decreases as the temperature of the droplet surface increases. It can be seen from the above that in the exemplary arrangement, in the technical solution of reducing the surface tension of the droplet surface by heating, the droplet may wet the capillary channel, or otherwise may not wet the capillary channel, and the capillary channel may be provided with a hydrophobic layer, or otherwise may also be provided without a hydrophobic layer. In case of that there is no hydrophobic layer on the inner surface of the capillary channel, the droplet may or may not wet the capillary channel, and the surface tension of the droplet may be reduced by heating the droplet surface. In addition, in case of that a hydrophobic layer is provided at the inner surface of the capillary channel, the droplet may also wet or not wet the capillary channel, and the surface tension of the droplet may be reduced by heating the droplet surface. In the present exemplary arrangement, the hydrophobic layer may increase the smoothness of movement of the droplet. The exemplary arrangement is described by taking an example in which there is no hydrophobic layer at the inner surface of the capillary channel.

In the present exemplary arrangement, a liquid inlet port 6 may be reserved at the surface of the first substrate 1 or the second substrate 2, and the liquid inlet port 6 communicates with a capillary channel 3 for feeding the droplet into the capillary channel. The first electrothermal component 4 may be selected as an electrothermal resistance wire which generates heat in a conducting state to heat the droplet. The first switch element 5 may be selected as a thin film transistor, the gate of the thin film transistor may be coupled with an integrated circuit, and the integrated circuit may simultaneously send a control signal to one or more thin film transistors so as to control one or more thin film transistors to be switched on to satisfy requirements on different movement states of the droplet. The capillary channel 3 may be designed into different shapes and sizes according to specific requirements. It should be understood by those skilled in the art that the first electrothermal component 4 and the first switch component 5 may have more options, which are all within the protection scope of the present disclosure.

In the exemplary arrangement, one way of forming the capillary channel may be: providing a microfluidic channel on a bonding surface of the first substrate 1 and/or the second substrate 2; the microfluidic channel defines the capillary channel 3 when the first substrate 1 is bonded to the second substrate 2. The above method is simple in process and has a lower cost; at the same time, the method may also facilitate an arrangement of the first switch element and the first electrothermal component. It should be noted that the capillary channel may be formed in other ways such as an integral molding technology, and these variations should be understood as belonging to the protection scope of the present disclosure.

In the exemplary arrangement, there are three implementable solutions for the arrangement of the capillary channel, including: providing the capillary channel 3 at the first substrate 1; providing the capillary channel 3 at the second substrate 2; and providing the capillary channel 3 at the first substrate 1 and the second substrate 2.

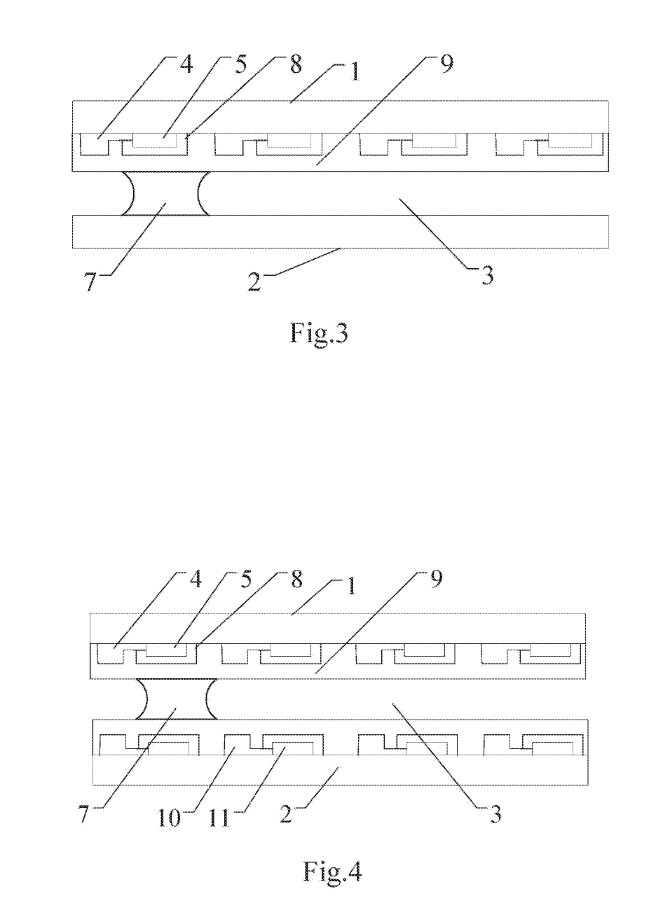

The exemplary arrangement is first described by providing the capillary channel 3 on the second substrate as shown in FIG. 3, which is a cross-sectional view along the capillary channel in an arrangement of the digital microfluidic chip of the present disclosure. The first switch element 5 is disposed at the first substrate 1, and the surface of the first switch element 5 is covered with an insulating material 8; the first electrothermal component 4 and the first switch element 5 are provided with a liquid-resisting material 9 at the surface of the insulating material; the liquid-resisting material 9 is a heat conductive material.

It should be noted that the first switch element 5 may be disposed at the same layer as the first electrothermal component 4, that is, not overlapped with each other, so as to improve compactness of the chip. The insulating material 8 may be selected as a polyvinyl chloride resin. The liquid-resisting material 9 may be selected as indium tin oxide, which has good thermal conductivity so as to quickly transfer heat of the first electrothermal component to the droplet.

In the exemplary arrangement, it is first described by the droplet 7 wetting the inner surface of the capillary channel 3. When the droplet 7 wet the inner surface of the capillary channel 3, a concave liquid surface is formed at each of both sides of the droplet 7 disposed at the capillary channel 3. The surface tension of the concave liquid surface on each side faces towards a direction where its respective side is positioned. Specifically, the surface tension of a left liquid surface faces towards the left; and the surface tension of a right liquid surface faces towards the right. When the first electrothermal component 4 disposed at the left side of the droplet heats the droplet, a temperature of the concave liquid surface at the left side of the droplet is higher than that of the concave liquid surface at the right side, and the surface tension at the left side of the droplet is smaller than that at the right side, such that the droplet moves towards the right under the action of the surface tension on the right side.

It should be noted that, when the droplet does not wet the capillary channel, the droplet forms a convex liquid surface at each of both sides of the capillary channel, wherein the surface tension of the convex liquid surface faces towards the interior of the droplet, i.e., the surface tension of the left liquid surface faces towards the right; the surface tension of the right-liquid surface faces towards the left. When the first electrothermal component disposed at the left side of the droplet heats the droplet, the temperature of the convex liquid surface at the left side of the droplet is higher than that of the convex liquid surface on the right side, and the surface tension at the left side of the droplet is smaller than the surface tension at the right side, such that the droplet moves to the left under the action of the surface tension at the right side. In the above exemplary arrangement, the capillary channel 3 is disposed at the second substrate 2, and the first electrothermal component 4 is disposed at the first substrate 1. There is a certain error when the first substrate 1 is bonded to the second substrate 2, which causes the first electrothermal component 4 cannot be strictly distributed in the extending direction of the capillary channel 3. The present exemplary arrangement also proposes a method of providing the capillary channel: the capillary channel 3 is disposed at the first substrate 1.

It should be noted that, in the present exemplary arrangement, a microfluidic channel is formed at the first substrate 1, and a first electrothermal component 4, a first switch element 5, an insulating material and a liquid-resisting material are disposed within the microfluidic channel. When the second substrate 2 is bonded to the first substrate 1, the microfluidic channel defines the capillary channel 3. At this time, the electrothermal component 4 are strictly distributed in the extending direction of the capillary channel 3.

In the above exemplary arrangement, the droplet 7 is heated only by the first electrothermal component 4 distributed at the first substrate 1 with a lower heating speed. As shown in FIG. 4, a cross-sectional view along the capillary channel in an arrangement of the digital microfluidic chip of the present disclosure is shown. In the exemplary arrangement, a plurality of second electrothermal components 10 and a plurality of second switch elements 11 may also be included. The plurality of second electrothermal components 10 may be disposed at the second substrate 2 and distributed to be spaced apart in the extending direction of the capillary channel 3; each of the second switch elements 11 is coupled with a current circuit with which one of the second electrothermal components 10 is coupled, and receives a control signal to control closure of the current circuit with which the plurality of second electrothermal components 10 are coupled.

In this arrangement, the capillary channel 3 may have a plurality of extending directions, and extending directions of the first electrothermal component 4 and the second electrothermal component 10 may be the same or different. For example, the first electrothermal component 4 and the second electrothermal component 10 may be parallel, crossed, aligned, staggered, or the like.

It should be noted that the second electrothermal component 10 may also be selected as an electrothermal resistance wire which generates heat in a conducting state to heat the droplet. The second switch element 11 may be selected as a thin film transistor disposed at the second substrate 2, and disposed in the same layer as the second electrothermal component to improve compactness of the chip. The first switch element 5 and the second switch element 11 may be coupled with the same integrated circuit. The integrated circuit may simultaneously transmit control signals to the first switch element 5 and the second switch element 11 to conduct the current circuit with which the first electrothermal component 4 and the second electrothermal component 10 are coupled. The first electrothermal component 4 and the second electrothermal component 10 are controlled to simultaneously generate heat, thus achieving rapid heating of the droplet. The first electrothermal component 10 and the first switch element 11 are provided with a liquid-resisting material at the surface of the insulating material; the liquid-resisting material is a heat conductive material. The insulating material may be selected as a polyvinyl chloride resin. The liquid-resisting material 9 may be selected as indium tin oxide, which has good thermal conductivity so as to quickly transfer heat of the first electrothermal component to the droplet.

It should be noted that the microfluidic channel may be disposed at the second substrate 2, or otherwise may not be disposed at the second substrate 2. In case of that the microfluidic channel is not disposed at the second substrate 2, the second electrothermal component 10 may be directly disposed at the second substrate, and when the second substrate is bonded to the first substrate, the microfluidic channel at the first substrate defines a capillary channel. In case of that the microfluidic channel is disposed at the second substrate, the second electrothermal component is disposed at the microfluidic channel, and when the first substrate is bonded to the second substrate, the microfluidic channel at the first substrate and the microfluidic channel at the second substrate are disposed opposite to each other, and combined to define a capillary channel.

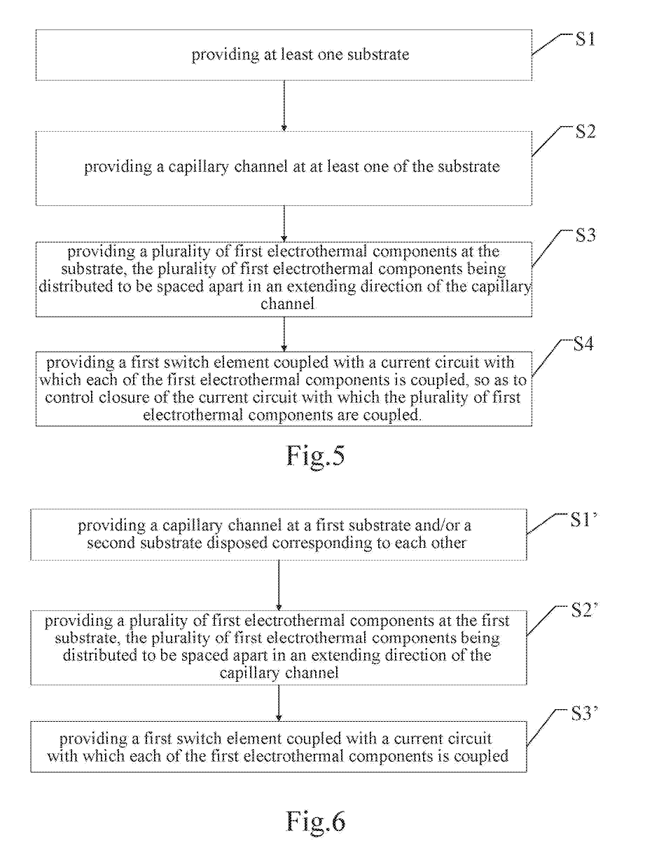

The exemplary arrangement further provides a fabricating method of a digital microfluidic chip. As shown in FIG. 5, a flowchart of an arrangement of a fabricating method of a digital microfluidic chip is shown. The fabricating method of a digital microfluidic chip includes:

S1: providing at least one substrate;

S2: providing a capillary channel at at least one of the substrate;

S3: providing a plurality of first electrothermal components at the substrate, the plurality of first electrothermal components being distributed to be spaced apart in an extending direction of the capillary channel; and

S4: providing a first switch element coupled with a current circuit with which each of the first electrothermal components is coupled, so as to control closure of the current circuit with which the plurality of first electrothermal components are coupled.

As shown in FIG. 6, a flowchart of another arrangement of a fabricating method of a digital microfluidic chip is shown. The fabricating method of a digital microfluidic chip includes:

S1′: providing a capillary channel at a first substrate and/or a second substrate disposed corresponding to each other;

S2′: providing a plurality of first electrothermal components at the first substrate, the plurality of first electrothermal components being distributed to be spaced apart in an extending direction of the capillary channel; and

S3′: providing a first switch element coupled with a current circuit with which each of the first electrothermal components is coupled, so as to control closure of the current circuit with which the plurality of first electrothermal components are coupled.

In the exemplary arrangement, the method further includes:

providing a plurality of second electrothermal components on the second substrate, the second electrothermal components being distributed to be spaced apart in the extending direction of the capillary channel;

providing a second switch element coupled with a current circuit with which the plurality of second electrothermal components are coupled to control closure of the current circuit.

In the exemplary arrangement, providing a capillary channel at a first substrate and/or a second substrate disposed corresponding to each other includes:

providing a microfluidic channel at bonding surfaces of the first substrate and/or the second substrate;

bonding the second substrate at the first substrate, the microfluidic channel defines the capillary channel.

In the exemplary arrangement, providing a first switch element coupled with a current circuit with which each of the first electrothermal components is coupled includes: before the second substrate is bonded to the first substrate, providing the first switch element at the first substrate;

providing a second switch element coupled with a current circuit with which the plurality of second electrothermal components are coupled includes: before the second substrate is bonded to the first substrate, providing the second switch element at the second substrate; and covering surfaces of the first switch element and the second switch element with an insulating layer.

In the exemplary arrangement, before the second substrate is bonded to the first substrate, the method further includes:

providing a liquid-resisting material at surfaces of the first electrothermal component, the second electrothermal component, and the first switch element, the second switch element, and the insulating layer.

It should be noted that the digital microfluidic chip fabricated by the fabricating method thereof provided by the exemplary arrangement has the same structure as the digital microfluidic chip provided by the exemplary arrangement, and the working principle and the analysis of technical characteristics thereof have been described in detail in the description of the digital microfluidic chip, which will not be described herein.

The exemplary arrangement further provides a control method of a digital microfluidic chip, including:

realizing a directional movement of a droplet within the digital microfluidic chip by varying a temperature on both sides of the droplet within the digital microfluidic chip.

It should be noted that the control method of a digital microfluidic chip may be applied to a digital microfluidic chip including a capillary channel, a plurality of electrothermal components and a plurality of switch elements. The plurality of electrothermal components are distributed to be spaced apart in an extending direction of the capillary channel, and each of the switch elements is coupled with a current circuit with which one of the electrothermal component is coupled. The method includes: controlling the switch element to conduct a current circuit with which the electrothermal components are coupled, so as to ensure the electrothermal components generate heat; heating the droplet at different positions by the electrothermal component at different positions to achieve a temperature difference on both sides of the droplet.

It can be seen from the above technical solutions that the advantages and positive effects of the digital microfluidic chip, the fabricating method of the same and the control method of the same of the present disclosure are as follows:

The present disclosure provides a digital microfluidic chip, a fabricating method and a control method thereof. The digital microfluidic chip varies a surface tension on both sides of the droplet by varying a temperature on both sides of the droplet in the capillary channel at the chip, thus causing the surface tension on both sides of the droplet to be unbalanced, and thus realizing a directional movement of the droplet within the capillary channel. Compared with the related art, on the one hand, the digital microfluidic chip can realize the directional movement of the droplet without providing a hydrophobic layer, it also has a simple structure, low cost and may be recycled. On the other hand, the digital microfluidic chip has a larger driving force.

Other arrangements of the present disclosure will be apparent to those skilled in the art after reading the specification and implementing the invention disclosed herein. The present application is intended to cover any variations, purposes, or adaptations of the present disclosure, which are in accordance with the general principles of the present disclosure and include common general knowledge or conventional technical means in the art that are not disclosed in the present disclosure. The specification and arrangements are to be regarded as illustrative only, and the real scope and spirit of the present disclosure is defined by the attached claims.

The features, structures, or characteristics described above may be combined in any suitable manner in one or more arrangements, and the features discussed in the various arrangements are interchangeable, if possible. In the above description, numerous specific details are set forth to fully understand arrangements of the present disclosure. However, one skilled in the art will appreciate that the technical solution of the present disclosure may be practiced without one or more of the specific details, or other methods, components, materials, and the like may be employed. In other instances, well-known structures, materials or operations are not shown or described in detail to avoid obscuring aspects of the present disclosure.

What is claimed is:

1. A digital microfluidic chip, comprising:
at least one substrate;
a capillary channel disposed at at least one of the substrate;
a plurality of first electrothermal components disposed at at least one of the substrate and distributed to be spaced apart in an extending direction of the capillary channel; and
a plurality of first switch elements, each of the first switch elements being coupled with a current circuit with which the first electrothermal components are coupled, and receiving a control signal to control closure of a current circuit coupled with which the plurality of first electrothermal components are coupled.

2. The digital microfluidic chip according to claim 1, the substrate comprises a first substrate and a second substrate disposed opposite to the first substrate; the capillary channel is disposed at at least one of the first substrate or the second substrate; and the plurality of first electrothermal components are disposed at the first substrate.

3. The digital microfluidic chip according to claim 2, further comprising:
a plurality of second electrothermal components disposed at the second substrate and distributed to be spaced apart in the extending direction of the capillary channel; and
a plurality of second switch elements, each of the second switch elements being coupled with a current circuit with which the second electrothermal components are coupled, and receiving a control signal to control closure of a current circuit with which the plurality of second electrothermal components are coupled.

4. The digital microfluidic chip according to claim 2, surfaces of the first switch element and the second switch element are covered with an insulating material.

5. The digital microfluidic chip according to claim 2, a bonding surface of the at least one of the first substrate or the second substrate is disposed with a microfluidic channel; the bonding surface of the first substrate is disposed opposite to the bonding surface of the second substrate;
the first substrate is bonded to the second substrate, and the microfluidic channel defines the capillary channel.

6. The digital microfluidic chip according to claim 3, a bonding surface of the at least one of the first substrate or the second substrate is provided with the microfluidic channel;
the first substrate is bonded to the second substrate, and the microfluidic channel defines the capillary channel.

7. The digital microfluidic chip according to claim 5, the bonding surface of the first substrate is provided with the microfluidic channel, the second substrate is bonded to the first substrate, and the microfluidic channel of the bonding surface of the first substrate defines the capillary channel.

8. The digital microfluidic chip according to claim 5, the bonding surfaces of the first substrate and the second substrate are provided with microfluidic channels, the first substrate is bonded to the second substrate, and the microfluidic channel at the bonding surface of the first substrate and the microfluidic channel at the bonding surface of the second substrate are disposed opposite to each other, and combined to define the capillary channel.

9. The digital microfluidic chip according to claim 4, surfaces of the first electrothermal component, the second electrothermal component, and the insulating material are provided with liquid-resisting material.

10. The digital microfluidic chip according to claim 9, said liquid-resisting material is a thermally conductive material.

11. The digital microfluidic chip according to claim 9, the first electrothermal component and the second electrothermal component are electrothermal resistance wires, the insulating material is polyvinyl chloride resin, and the liquid-resisting material is indium tin oxide.

12. The digital microfluidic chip according to claim 3, the first switch element is disposed at the same layer as the first electrothermal component, and the second switch element is disposed at the same layer as the second electrothermal component.

13. The digital microfluidic chip according to claim 3, at least one of the first switch element or the second switch element are thin film transistors.

14. The digital microfluidic chip according to claim 1, an inner surface of the capillary channel is not provided with a hydrophobic layer.

15. A fabricating method of a digital microfluidic chip, comprising:
providing at least one substrate;
providing a capillary channel at at least one of the substrate;
providing a plurality of first electrothermal components at the substrate, the plurality of first electrothermal components being distributed to be spaced apart in an extending direction of the capillary channel; and
providing a first switch element coupled with a current circuit with which each of the first electrothermal components is coupled, so as to control closure of the current circuit with which the plurality of first electrothermal components are coupled.

16. The fabricating method of a digital microfluidic chip according to claim 15, the substrate comprises a first substrate and a second substrate disposed opposite to the first substrate; the capillary channel is disposed at at least one of the first substrate or the second substrate; and the plurality of first electrothermal components are disposed at the first substrate.

17. The fabricating method of a digital microfluidic chip according to claim 16, further comprising:
providing a plurality of second electrothermal components at the second substrate, the second electrothermal components being distributed to be spaced apart in the extending direction of the capillary channel; and
providing a second switch element coupled with a current circuit with which the plurality of second electrothermal components are coupled to control closure of the current circuit.

18. The fabricating method of a digital microfluidic chip according to claim 16, providing a capillary channel at the at least one of a first substrate or a second substrate disposed corresponding to each other comprises:
providing a microfluidic channel at bonding surfaces of the at least one of the first substrate or the second substrate;
bonding the second substrate at the first substrate, in which the microfluidic channel defines the capillary channel.

19. The fabricating method of a digital microfluidic chip according to claim 17, providing a capillary channel at the at least one of a first substrate or a second substrate disposed corresponding to each other comprises:
providing a microfluidic channel at a bonding surface of the at least one of the first substrate or the second substrate; and
bonding the second substrate to the first substrate, the microfluidic channel defining the capillary channel.

20. A control method of a digital microfluidic chip, comprising:
realizing a directional movement of a droplet within the digital microfluidic chip by varying a temperature on both sides of the droplet within the digital microfluidic chip.

21. The control method of a digital microfluidic chip according to claim 20, applied to a digital microfluidic chip comprising a capillary channel, a plurality of electrothermal components, and a plurality of switch elements; the plurality of electrothermal components being distributed to be spaced apart in an extending direction of the capillary channel, and each of the switch elements being coupled with a current circuit with which one of the electrothermal component is coupled; the method comprises:
controlling the switch element to conduct a current circuit with which the electrothermal components are coupled, so as to ensure the electrothermal components generate heat; and
heating the droplet at different positions by the electrothermal component at different positions to achieve a temperature difference on both sides of the droplet.
